(19) United States
(12) Patent Application Publication
(10) Pub. No.: US 2010/0110196 A1
(43) Pub. Date: May 6, 2010

(54) System and Method for Encoding Authentication

(76) Inventor: Philip Wesby, Stratford-upon-Avon (GB)

Correspondence Address: Sunstein Kann Murphy & Timbers LLP, 125 SUMMER STREET, BOSTON, MA, 02110-1618, US

(21) Appl. No.: 12/531,183

(22) PCT Filed: Mar. 12, 2008
(86) PCT No.: PCT/GB08/00842

§ 371 Date: Dec. 4, 2009

(30) Foreign Application Priority Data
Mar. 15, 2007 (GB) 0704947.1

(51) Int. Cl. H04N 7/18; G06K 9/18; G05B 19/00; G06K 9/00; G06F 21/00

(52) U.S. Cl. 348/161; 382/182; 340/5.7; 340/5.53; 726/2; 348/E07.085

(57) ABSTRACT

A system and method for encoding and authenticating documents and data storage discs uniquely is described which can provide a means to authenticate a document such as a passport or identification document or driving licence or contract or a music compact disc (CD) or data CD or DVD or holographic DVD or credit card. The documents each comprise an encoding formed from a unique number or pattern or datagram image, which is either printed so that it can be read directly by a viewing device, or the encoding is cut by laser to create a pattern or perforation matrix into the document thereby leaving the unique number or pattern or datagram as a matrix of small holes or perforations in the document through which light may pass. The authentication process thus involves viewing and decoding the encoding and generating a computed result using a stored decoding algorithm. Different levels of decoding may be linked to subscriber access privileges and these may be controlled by subscriber identity data and or a finger print capture and validation sensor.

### BACKGROUND OF THE INVENTION

The current invention relates to a system and method for encoding and authentication of documents and data storage compact discs or music storage compact discs (CDs) or DVDs or holographic DVDs or credit cards.

In particular, the invention relates to a system and method for encoding documents or CDs or credit cards with a unique pattern or number or alphanumeric sequence or datagram or a sequence of characters in any language character set as a means to authenticate the documents or CDs.

More particularly, when applied to paper documents, the invention relates to a system and method for authenticating documents such as passports, driving licences, personal identification documents, contracts, deeds of ownership, promissory notes and the like, wherein a laser device is used to encode documents with an authenticating unique number or pattern or datagram during the manufacturing process.

This patent application relates in part to an invention of an earlier patent application United Kingdom Patent Application 0619761.0 by the same applicant entitled System and Method for Data Acquisition and Processing having priority date Oct. 6, 2006. In this patent application is taught the method of using datagrams and combining these with user profiles stored within the data capture device, such as a mobile phone or PDA, to create a range of differentiated services.

The current invention can also be considered as one further application of the use of datagrams according to one embodiment of the current invention.

Further to the limitations of existing methods used for enhancing document security, and methods used for enhancing CD authenticity, and so far as is known, no optimum system and method for uniquely encoding documents or CDs using a laser cutting method is presently available which is directed towards the specific needs of this problem area as outlined.

### OBJECTS OF THE INVENTION

Accordingly, it is an object of the present invention to provide an improved system and method for encoding and authenticating documents such as a passport or identification document or driving licence or contract or promissory note or bank note and the like, in which a unique number or pattern or datagram image or sequence of characters in any language is encoded in or onto the surface of a document or upon a label or foil or hologram or Optically Variable Device (OVD) associated with, and firmly adhered to, the document, or encoded as a perforation matrix into the document.

It is a further object of one embodiment of the present invention to provide a system and method for encoding and authenticating documents in which a unique encoding comprising a number or pattern or datagram image or sequence of characters in any language is encoded by way of a laser process wherein the laser cuts the said unique encoding into an optically variable device at the end of the document manufacture process and the authenticating process involves decoding the unique encoding using an optical processing device comprising a camera and a decoding algorithm.

It is a further object of one embodiment of the present invention to provide a system and method for encoding and authenticating documents wherein the decoding optical processing device may comprise a mobile phone having a camera and display screen or a multi media computer having a camera and display screen or a PDA having a camera and display screen or a fixed line processing device connected to an optical scanner or camera and a display screen.

It is a further object of one embodiment of the present invention to provide a system and method for encoding and authenticating documents wherein the authenticity of each encoded document is determined by capturing and or scanning the encoding on the document using a camera connected to an optical processing device and decoding the encoding using a decoding algorithm wherein the decoding process will generate a message or pattern on the screen of the device if the encoding is authentic.

It is a further object of one embodiment of the present invention to provide a system and method for encoding and authenticating documents wherein the decoding device comprises a decoding algorithm which is able to determine the complex relationship between elements of the encoded pattern or datagram and the device is a mobile phone or multi media computer and wherein the algorithm for decoding runs as an application on the said mobile phone or multi media computer so that a subscriber can use his or her multi media computer to authenticate documents and the like by capturing an image of the encoding on the document, processing the encoding and generating a result to be viewed.

It is a further object of one embodiment of the present invention to provide a system and method for encoding and authenticating wherein the encoding may comprise a perforation matrix and the decoding operation involves placing the encoded document upon a sensor and shining light through the perforation such that the sensed pattern of light can be detected by the sensor and decoded wherein a display screen shows the result of the authentication process.

It is a further object of one embodiment of the present invention to provide a system and method for encoding and authenticating wherein the encoding may comprise a perforation matrix and the documents may comprise tickets to validate access to a service or location and wherein the encoding must be read and decoded and authenticated before access to the service or location is permitted.

It is a further object of one embodiment of the present invention to provide a system and method for encoding and authenticating wherein encoded labels comprising data in a compressed form are attached to products and wherein a consumer may use a multi media device to decode and read specific information about the product and or to verify that the product is authentic.

It is a further object of one embodiment of the present invention to provide a system and method for encoding and authenticating wherein the algorithm for decoding is downloaded as an application such as a Java applet and wherein different levels of decoding are permitted according to the privileges of the subscriber therein permitting different access rights to different subscribers.

It is a further object of one embodiment of the present invention to provide a system and method for encoding and authenticating wherein the algorithm for decoding may read unique data stored within the wireless or fixed image-capturing device such as the Equipment Identity Number and or the SIM card identity and or some other unique encoded data and thereby link the decoding operation to a particular device or subscriber identity.

It is a further object of one embodiment of the present invention to provide a system and method for encoding and authenticating wherein the algorithm for decoding may read unique data stored within the wireless or fixed image capturing device and wherein the user or subscriber may be asked to input personal identification data to enable the decoding to proceed such as a PIN number or to activate a finger print capture and validation process.

Other objects and advantages of this invention will become apparent from the description to follow when read in conjunction with the accompanying drawings.

### BRIEF SUMMARY OF THE INVENTION

Certain of the foregoing and related objects are readily-attained according to the present invention by the provision of a novel system and method for encoding and authentication.

Documents comprising an encoding formed from a unique number or pattern or datagram image are captured by a viewing device such as a mobile phone with a camera, or a multi media computer, or a fixed line device, and wherein the encoding is decoded using a decoding algorithm and if the encoding is authentic a result is generated on a viewing screen. Non-encoded visible data on the document may be compared with the decoded result to determine that the document is authentic.

Documents may comprise a perforation matrix cut into the document thereby creating a pattern of holes wherein the encoding may be read using transmitted light shone through the perforation. The invention may be applied to tickets to permit access to a service or location wherein access is permitted if the ticket is determined to be authentic.

Different levels of decoding may be linked to subscriber access privileges and these may be controlled by subscriber identity data and or a finger print capture and validation sensor wherein the algorithm and decoding process requests identity data and or the input of a finger print scan.

Other objects and features of the present invention will become apparent from the following detailed description considered in connection with the accompanying drawings, which disclose several key embodiments of the invention. It is to be understood, however, that the drawings are designed for the purpose of illustration only and that the particular applications are given by way of example only and do not limit the scope of the invention.

### BRIEF DESCRIPTION OF THE DRAWING

FIG. 1 illustrates how a mobile phone or multi media computer may be used to authenticate a document.

### DESCRIPTION OF A PREFERRED EMBODIMENT

Reference will now be made in detail to some specific embodiments of the invention including the best modes contemplated by the inventor for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as defined by the appended claims. The following description makes full reference to the detailed features as outlined in the objects of the invention.

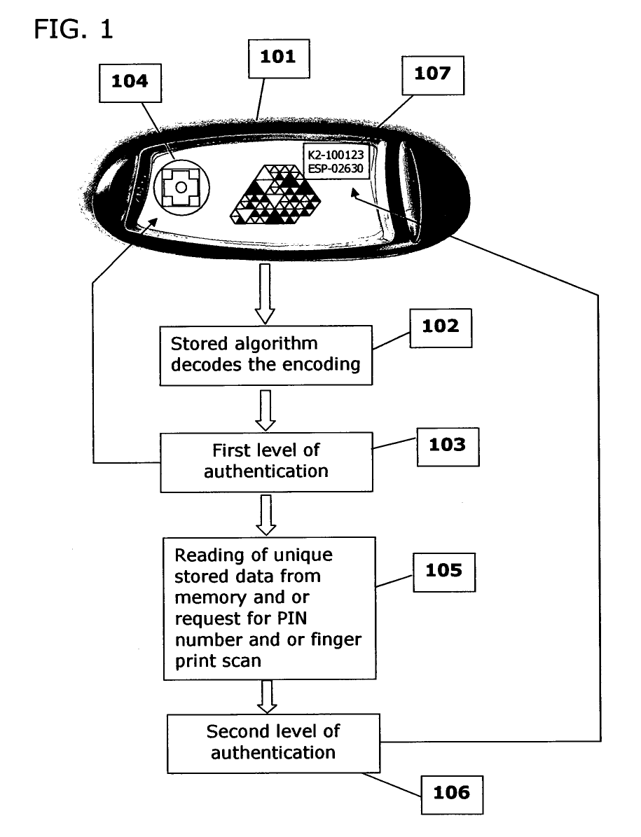

Referring now in detail to the drawings and in particular FIG. 1 thereof, therein illustrated is a schematic showing how a mobile phone or multi media computer may be used to authenticate a document.

A multi media computer (101) is used to capture an image of the encoding on the document. A stored algorithm decodes the encoding (102) and generates a first level of authentication (103) by displaying a result (104) such as a symbol or pattern or sequence of characters on the display screen of the multi media computer (101).

This result (104) may be compared with a non-encoded sequence of characters or a pattern on the document and thereby determine the authenticity of the document.

A second level of authentication (106) may be performed on the encoding by reading unique data (105) stored in the memory of the multi media computer and or by validating personal identity information such as entering a PIN number or speaking a sequence of words into a microphone and or by entering a finger print using a finger print capture and validation process.

Authentication of the stored data and or the personal identity information may generate additional information on the screen (107) from the encoding which can be further used to determine other aspects of the document authentication such as document origin and document type and the like.

The camera device associated with the multi media computer may comprise extended sensitivity in different areas of the electromagnetic spectrum such as enhanced sensitivity to certain wavelengths such as infra red or ultra violet and thus enable the decoding and processing of data which is not easily discernible by the human eye. Consequently, the use of a multi media computer thus enables the viewing and decoding of hidden and or encoded data to validate the document's authenticity.

In a separate application, the document may be a ticket such as an entry ticket to an event or a car park ticket and comprise either a surface-printed encoding or a perforation matrix encoding wherein the ticket is entered into a card reading device which comprises the capability to read the encoding either by imaging or by shining light through the perforation. The gathered encoded data is then decoded and if the ticket is determined to be authentic, a command is given to permit entry or to open a car park barrier.

Access to all manner of services and or activation of all manner of machinery may be controlled by the authentication of documents in this way.

According to one embodiment, the key advantage of the invention is to enable persons with camera-enabled mobile phones or multi media computers to validate and authenticate documents by making use of the decoding capabilities of a decoding algorithm and the imaging capabilities of the camera devices associated with multi media computers.

In alternative embodiments, the encoding may be illuminated by radiation of one or more ranges of different wavelengths to reveal or to enhance the image of the encoding. For this purpose, the fixed or wireless camera device may comprise a light source capable of illuminating the encoding with light of the said one or more ranges of different wavelengths.

The following sequence of steps makes possible the authentication of a document according to the current invention.
1. The camera of the device is enabled.
2. The image of the encoding is captured by the camera or viewed as a real time image.
3. The captured encoding is decoded using the stored algorithm.
4. The result of the decoding is displayed on the screen associated with the device.
5. By comparison with non-encoded data printed on the document, the authentication of the document is determined.

This method is equally applicable to validate travel documents and or driving licences and other documents using the capabilities of a multi media computer.

While the present invention has been described herein with reference to particular embodiments thereof, a latitude of modification, various changes, and substitutions are intended in the present invention. In some instances, features of the invention can be employed without a corresponding use of other features, without departing from the scope of the invention as set forth. Therefore, many modifications may be made to adapt a particular configuration or method disclosed, without departing from the essential scope and spirit of the present invention. It is intended that the invention not be limited to the particular embodiments disclosed, but that the invention will include all embodiments and equivalents falling within the scope of the claims.

What is claimed is:

1. A method for authenticating a document or data storage compact disc or music storage compact disc (CD) or DVD or holographic DVD or credit card or product identification label or identification document comprising a unique encoding comprising a number or pattern or datagram image or sequence of characters in any language, wherein
said unique encoding being encoded by way of a laser process wherein a laser cutting said unique encoding into an optically variable device at the end of the document manufacturing process with an authenticating unique number or pattern or datagram during said manufacturing process, said method being characterised by the steps of:
capturing an image of the encoding on said document by a multi media computer comprising a camera device or by a camera-enabled mobile phone, or by a fixed line device comprising a camera, decoding said encoding by a stored algorithm for generating a first level of authentication by displaying a result wherein said result being a symbol or pattern or sequence of characters on the display screen of said multi media computer, or mobile phone or fixed line device, comparing said result with a non-encoded sequence of characters or a pattern on the document for determining the authenticity of said document.

2. A method as disclosed in claim 1 further comprising the steps of, performing a second level of authentication on said encoding by:
a. reading unique data stored in the memory of said multi media computer or mobile phone or fixed line device and/or
b. validating personal identity information wherein said personal identity information being an entered PIN number or a spoken sequence of words into a microphone and/or
c. entering a finger print using a finger print capture and validation process.

3. A method as disclosed in claim 2 further comprising the steps of, generating additional information on the screen from said encoding for determining one or a plurality of aspects of the document authentication wherein said one or a plurality of aspects being document origin and/or document type.

4. A method as disclosed in claim 3 further comprising the steps of decoding and processing of data which is not easily discernible by the human eye wherein said multi media computer associated camera device further comprising extended sensitivity in a plurality of different areas of the electromagnetic spectrum wherein said extended sensitivity being an enhanced sensitivity to certain wavelengths wherein said wavelengths being infra red or ultra violet for, viewing and decoding hidden and/or encoded data in order to validate the authenticity of said document.

5. A method as disclosed in claim 1 wherein said document being a ticket wherein said ticket being an entry ticket to an event or a car park ticket and comprising either a surface-printed encoding and/or a perforation matrix encoding wherein said ticket being entered into a card reading device comprising the capability to read the encoding either by imaging or by shining light through said perforation and further comprising the steps of decoding said gathered encoded data and if said ticket being determined to be authentic giving a command to permit entry or to open a car park barrier.

6. A method as disclosed in claim 5 wherein said step of decoding and processing of data which is not easily discernible by the human eye being preceded by the step of; illuminating said encoding by radiation of one or more ranges of said different wavelengths to reveal or to enhance the image of the encoding wherein said fixed or wireless camera device comprising a light source capable of illuminating the encoding with light of the said one or more ranges of said different wavelength.

7. A method as disclosed in claim 1 further comprising the steps of; controlling access to all manner of services and or activation of all manner of machinery by said authentication of said documents, wherein decoding said gathered encoded data and if said ticket being determined to be authentic giving a command to permit entry or to open a car park barrier.

8. A method as disclosed in claim 7 wherein said documents being a passport or identification document or product identification label or driving licence or contract or promissory note or bank note, wherein a unique number or pattern or datagram image or sequence of characters in any language being encoded in or onto the surface of said document or upon a label or foil or hologram or Optically Variable Device (OVD) associated with, and firmly adhered to, said document, or encoded as a perforation matrix into said document.

9. A method as disclosed in claim 5 wherein said documents being a passport or identification document or product identification label or driving licence or contract or promissory note or bank note, wherein a unique number or pattern or datagram image or sequence of characters in any language being encoded in or onto the surface of said document or upon a label or foil or hologram or Optically Variable Device (OVD) associated with, and firmly adhered to, said document, or encoded as a perforation matrix into said document.
